(19) United States
(12) Patent Application Publication
(10) Pub. No.: US 2014/0260160 A1
(43) Pub. Date: Sep. 18, 2014

(54) MULCH PLATE ASSEMBLY

(71) Applicant: BRIAN BAKER, WILMINGTON, NC (US)

(72) Inventor: BRIAN BAKER, WILMINGTON, NC (US)

(21) Appl. No.: 14/217,093

(22) Filed: Mar. 17, 2014

Related U.S. Application Data
(60) Provisional application No. 61/801,151, filed on Mar. 15, 2013.

(51) Int. Cl. A01D 34/00

(52) U.S. Cl. CPC A01D 34/005
USPC 56/16.8; 56/320.2

(57) ABSTRACT

The present invention is a mulch plate assembly in a rotary lawnmower having a deck member featuring a discharge aperture wherein grass clippings and the like are discharged during use of the lawnmower, the mulch plate assembly comprising a rigid plate member, attachment means whereby the rigid plate is attached to the deck member in position to obstruct the discharge aperture, the attachment means capable of disengagement by a single unidirectional application of force by a user.

### CROSS-REFERENCE TO RELATED APPLICATIONS

This application claims the benefit of priority to U.S. Provisional Application No. 61/801,151 filed Mar. 15, 2013. The content of U.S. Provisional Application No. 61/801,151 is incorporated by reference herein in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(a) Field of the Invention

The present invention is in the technical field of devices designed for use in the field of lawn care. More particularly, the present invention is in the technical field of lawnmowers, generally. Still more particularly, the present invention is in the technical field of lawnmower mulch plate assemblies.

(b) Background Art

In a rotary power lawnmower of the pushing or riding type, a deck member is typically fabricated from steel or aluminum and has a downwardly projecting skirt portion to define a downwardly facing cavity or chamber. The deck member is supported for ground traversing movement by a set of four wheels which are adjustable for changing the height of the deck member relative to the ground. In the case of a rotary power lawnmower of the pushing type, a gasoline engine is commonly mounted on the deck member and includes a vertical shaft which projects downwardly through the deck member into the chamber, the vertical shaft supporting a grass cutting blade having sharpened outer edge portions and the cutting blade being suspended from the vertical shaft in a roughly horizontal plane within the downwardly facing cavity or chamber defined by the deck member. In the case of a rotary power lawnmower of the riding type, the analog gasoline engine, vertical shaft, and cutting blade assembly exists, however, the gasoline engine is typically mounted behind a seat assembly that is mounted on the deck member.

Common in the prior art is a discharge outlet aperture in the downwardly projecting deck member skirt allowing the for the distribution of grass clippings propelled by the cutting blade back onto the ground. Frequently, this discharge outlet aperture is coupled with a deflector that extends down and outward from the deck member skirt, the deflector serving the purpose of deflecting the grass clippings expelled through the discharge outlet aperture down and outwardly from the lawnmower. Also known in the art is a duct-like component that couples to the discharge outlet aperture, forming an extension for the discharge outlet aperture and directing grass clippings discharged into a bag component that is attached to the duct-like component.

Further known in the art is the principle that fresh grass clippings are rich in nutrients and, therefore, serve as an excellent natural fertilizer for the lawn being cut. From time to time, a power lawnmower user will want the grass clippings to be spread over the lawn being cut to decay and fertilize the lawn. Likewise, the user will at other times want the grass clippings to be bagged or otherwise blown free from the lawn being cut. That said, the tendency in the prior art is mowers that expel grass clippings through a discharge outlet aperture either into a collection bag or in a such way as to leave the clippings in a concentrated and unnatural pattern that fails to evenly distribute the clippings across the lawn being cut. Further, because the function of the mower is to cut each blade of grass and then expel the grass clipping from the deck member cavity as soon as possible, the clippings expelled from mowers known in the prior art tend to be larger clippings as compared to clippings retained inside the deck member cavity for longer periods of time—clippings retained in the deck member cavity for longer periods of time are usually cut and diced multiple times and thus leave the cavity in smaller and multiple pieces. For the purposes of the present application, the finer cut grass clippings will be referred to as “mulch” and the act of dispersing the finer cut grass clippings for the purposes of decay and fertilization of the lawn will be referred to as “mulching”.

As identified above the prior art thoroughly addresses the problem of how to manage, discharge and dispose of grass clippings created during use of the power lawnmower. However, the prior art does not effectively address the problem of how to effectively retain and re-use grass clippings created during use of the power lawnmower. Accordingly, a need exists for a power lawnmower assembly specifically designed for the purpose of retaining grass clippings in the deck member cavity for as long as possible during use of the lawnmower, thus yielding finer cut grass clippings evenly dispersed over the area of lawn mowed at the election of a user. Accompanying this stated need in the prior art for a power lawnmower assembly specifically designed to better facilitate mulching, is the need for a power lawnmower assembly that is readily configurable by a user to either better facilitate mulching or to function as would a standard mower known in the prior art. Of specific importance to the configurable aspects of the mower would be the ease with which a user may configure the same. Omitting altogether or otherwise limiting the need for a user to utilize tools to configure the mower is deemed a preeminent need in the art, particularly in the circumstance of for-hire mowing companies for whom “time is money” and the delay occasioned by a complicated and tool-based configuration of the lawnmower assembly can negatively affect the company's bottom line.

### BRIEF SUMMARY OF THE INVENTION

Stated as broadly as possible, the present invention is a mulch plate assembly, in a power rotary lawnmower having a deck member cavity and a discharge outlet aperture in the otherwise enclosed deck member cavity, comprising a rigid plate, means whereby the rigid plate may interchangeably be configured to completely block the discharge outlet aperture or be configured such that the discharge outlet aperture is completely unobstructed, and means whereby the rigid plate may be interchangeably attached or detached from the deck member.

Further and as noted above, ease of use is considered a primary need in the prior art and, therefore, it is expressly contemplated that the now disclosed mulch plate assembly be designed in such way as to make its configuration and attachment or detachment to the deck member as efficient and quick of process as may be possible without compromising safety in the use of the lawnmower or the effectiveness of the lawnmower at accomplishing its primary task—cutting the grass. It is contemplated that the now disclosed mulch plate assembly should be easily configured while attached to the lawnmower and should be able to be easily removed from the lawnmower as needed. Therefore, in more detail, the broadest articulation of the invention as recited above may further comprise means by which the rigid plate may be completely released from the deck member of the lawnmower without the use of tools and by way of a single unidirectional application of force by the hand of a user, as well as simple and straightforward means to securely lock the rigid plate in a first “closed” orientation to the discharge outlet aperture, and simple and straightforward means to securely restrain the rigid plate in a second “open” orientation to the discharge outlet aperture.

The means whereby the rigid plate may be attached to the deck member is contemplated to be a hinging means, the means to feature all the hallmarks of commonly known hinge assemblies. By virtue of the hinging means, the rigid plate may pivot about a hinge axis thereby being easily manipulated by a user and being easily positioned in a down “closed” orientation or an up “open” orientation vis-a-vis the discharge outlet aperture in the deck member. As suggested above, it is deemed desirable that the hinge assembly be designed to enable disengagement and dismantling of the hinge assembly through a single unidirectional application of force by the hand or hands of a user. This enablement allows the full configuration of the mulch plate assembly by a user easily, efficiently, quickly and without the need for tools. In what is considered a best mode of the now disclosed invention, a user may dismantle the hinging means by removing a hinge pivot pin through a single application of a pulling or pushing force upon the hinge pivot pin, thereby releasing the rigid plate from the deck member. So as to avoid loss of any of the components of the assembly, it is further contemplated that both the hinge pivot pin and the rigid plate itself may be tethered directly to the deck member so that neither component is ever lost during use.

Further contemplated with regard to the now disclosed mulch plate assembly is a locking means whereby the rigid plate may be securely locked in a first “closed” position completely obstructing the discharge outlet aperture of the deck member cavity. Likewise, also contemplated is a restraint means whereby the rigid plate may be securely restrained in a second “open” position leaving the discharge outlet aperture of the deck member cavity completely unobstructed. The preferred embodiment of the now disclosed invention supposes that the restraint means would be a biased restraint comprising either a shock cord or a compression spring joined at a first end to the rigid plate and joined at a second end to the deck member such that when both ends are joined as provided, the rigid plate is restrained in an “open” position leaving the discharge outlet aperture completely unobstructed.

Specifically, the preferred embodiment supposes that the locking means will be a slide lock apparatus comprising two spaced protrusions from the deck member, each deck member protrusion having a perforation and both protrusion perforations being in a single vertical axis, at least one protrusion from the rigid plate having a perforation, and a pin having a cylindrical shaft of smaller diameter than the perforations in the deck member protrusions and the rigid plate protrusion and a head of larger diameter than the perforations in the deck member protrusions and the rigid plate protrusion. When the perforations in the deck member protrusions are in common vertical axis with the perforations of any rigid plate members, the pin may be inserted through all relevant perforations, thus locking the rigid plate and the deck member together. For the purposes of this application the locking means identified and explained in detail in this paragraph will be simply referred to as a “slide lock assembly”.

It is a primary object of the now disclosed invention to provide a power rotary lawnmower that is equally capable of standard mowing and disposal or collection of grass clippings during mowing or mulching at the election of a user.

It is a primary object of the now disclosed invention to provide a mulch plate assembly for installation on a power rotary lawnmower that enables the lawnmower to alternatively serve the functions of standard mowing and disposal or collection of grass clippings during mowing or mulching at the election of a user.

It is a primary object of the now disclosed invention to provide a power rotary lawnmower that may be easily and efficiently transitioned between the functions of standard mowing and disposal or collection of grass clippings during mowing to mulching at the election of a user and without need for the use of outside tools.

It is a primary object of the now disclosed invention to provide a mulch plate assembly for installation on a power rotary lawnmower that enables the lawnmower to be easily and efficiently transitioned between the functions of standard mowing and disposal or collection of grass clippings during mowing to mulching at the election of a user and without need for the use of outside tools.

It is a further object of the now disclosed invention to provide a mulch plate assembly for a power rotary lawnmower that may be conveniently engaged or disengaged without need of the assistance of tools and without fear of the loss of any components of the assembly.

It is a further object of the now disclosed invention to provide a mulch plate assembly for installation on a power rotary lawnmower that enables the lawnmower to conveniently transition between a standard mowing use and a mulching use without sacrificing the effectiveness of the lawnmower in either its standard mowing use or its mulching use.

### BRIEF DESCRIPTION OF THE SEVERAL VIEWS OF THE DRAWING(S)

FIG. 1 is a top view of a preferred embodiment of the presented inventive mulch plate assembly;

FIG. 2 is a side view of a preferred embodiment of the presented inventive mulch plate assembly;

FIG. 3 is a perspective view of a securing means mechanism of a preferred embodiment of the presented inventive mulch plate assembly; and

FIG. 4 is a side view of a preferred embodiment of the presented inventive mulch plate assembly, the view of FIG. 4 being an alternative configuration to that shown in FIG. 2.

### DETAILED DESCRIPTION OF THE INVENTION

Referring now to the invention in more detail, in FIG. 1 there is shown a mulch plate assembly in a rotary lawnmower, the rotary lawnmower having the attributes of a typical rotary lawnmower including a deck member 10, front right wheel 13, and rear right wheel 21. Though not intrinsic to the presently claimed invention nor the particular embodiment depicted in FIG. 1, the deck member 10, front right wheel 13, and rear right wheel 21 are now disclosed to provide a context and frame of reference for one of ordinary skill in the art to understand the placement of the now disclosed mulch plate assembly with regard to the standard rotary lawnmower. Integrated with the deck member 10 is a left hinge knuckle 20 and a right hinge knuckle 17 through which a hinge pin shaft 12 is run, said hinge pin shaft 12 also running through a second left hinge knuckle 19 and second right hinge knuckle 11, the second left hinge knuckle 19 and second right hinge knuckle 11 being integrated with a rigid plate 18 depicted in a “closed” orientation and being at a near perpendicular orientation to the top of the deck member 10. Further depicted in FIG. 1 is a partial view of a mechanism whereby the rigid plate 18 is secured in the “closed” position, the visible portion of the mechanism comprising a locking pin 16 run through the axial perforation of a first member 15 integrated with the face of the rigid plate 18, and a pin leash 14 affixed at one end to the locking pin 16 and at a second end to the hinge pin shaft 12. The hinge pin as depicted comprises a shaft 12 and a flattened head 22.

Referring now to the invention in more detail, in FIG. 2 there is shown a mulch plate assembly in a rotary lawnmower, the rotary lawnmower having the attributes of a typical rotary lawnmower including a deck member 10, front right wheel 13, and rear right wheel 21. Though not intrinsic to the presently claimed invention nor the particular embodiment depicted in FIG. 2, the deck member 10, front right wheel 13, and rear right wheel 21 are now disclosed to provide a context and frame of reference for one of ordinary skill in the art to understand the placement of the now disclosed mulch plate assembly with regard to the host rotary lawnmower. Integrated with the deck member 10 is a left hinge knuckle 20 and a right hinge knuckle 17 through which a hinge pin shaft 12 is run, said hinge pin shaft 12 also running through a second left hinge knuckle 19 and second right hinge knuckle 11, the second left hinge knuckle 19 and second right hinge knuckle 11 being integrated with a rigid plate 18 depicted in a “closed” orientation and being at a near perpendicular orientation to the top of the deck member 10. The hinge pin as depicted comprises a shaft 12 and a flattened head 22. Further depicted in FIG. 2 is a full view of a mechanism whereby the rigid plate 18 is secured in the “closed” position, the mechanism comprising a locking pin 16, a first member 15 integrated with the face of the rigid plate 18, a second member 23 integrated with the side of the deck member 10, a third member 24 integrated with the side of the deck member 10, and a pin leash 14 affixed at one end to the locking pin 16 and at a second end to the hinge pin shaft 12. The mechanism whereby the rigid plate 18 is secured in the “closed” position works by insertion of the locking pin 16 into coaxial perforations in the first member 15 integrated with the face of the rigid plate 18, the second member 23 integrated with the side of the deck member 10, and the third member 24 integrated with the side of the deck member 10.

Referring now to the invention in more detail, in FIG. 3 there is shown a mulch plate assembly in a rotary lawnmower, the rotary lawnmower having the attributes of a typical rotary lawnmower including a deck member 10 and a front right wheel 13. Though not intrinsic to the presently claimed invention nor the particular embodiment depicted in FIG. 3, the deck member 10 and front right wheel 13 are now disclosed to provide a context and frame of reference for one of ordinary skill in the art to understand the placement of the now disclosed mulch plate assembly with regard to the host rotary lawnmower. FIG. 3 is a perspective view of the same preferred embodiment depicted in FIG. 1 and FIG. 2, the perspective being an up-close detailed view of the mechanism whereby the rigid plate 18 is secured in the “closed” position. Referring now to FIG. 3 in more detail, integrated with the deck member 10 is a right hinge knuckle 17 through which a hinge pin shaft 12 is run, said hinge pin shaft 12 also running through a second right hinge knuckle 11, the second right hinge knuckle 11 being integrated with a rigid plate 18 depicted in a “closed” orientation and being at a near perpendicular orientation to the top of the deck member 10. The hinge pin as depicted comprises a shaft 12 and a flattened head 22. As noted above, the reason for inclusion of FIG. 3 is to present a more detailed full view of the mechanism whereby the rigid plate 18 is secured in the “closed” position, the mechanism comprising a locking pin 16, a first member 15 integrated with the face of the rigid plate 18, a second member 23 integrated with the side of the deck member 10, a third member 24 integrated with the side of the deck member 10, and a pin leash 14 affixed at one end to the locking pin 16 and at a second end to the hinge pin shaft 12. The mechanism whereby the rigid plate 18 is secured in the “closed” position works by insertion of the locking pin 16 into coaxial perforations in the first member 15 integrated with the face of the rigid plate 18, the second member 23 integrated with the side of the deck member 10, and the third member 24 integrated with the side of the deck member 10.

Referring now to the invention in more detail, in FIG. 4 there is shown a mulch plate assembly in a rotary lawnmower, the rotary lawnmower having the attributes of a typical rotary lawnmower including a deck member 10, front right wheel 13, and rear right wheel 21. Though not intrinsic to the presently claimed invention nor the particular embodiment depicted in FIG. 4, the deck member 10, front right wheel 13, and rear right wheel 21 are now disclosed to provide a context and frame of reference for one of ordinary skill in the art to understand the placement of the now disclosed mulch plate assembly with regard to the host rotary lawnmower. Integrated with the deck member 10 is a left hinge knuckle 20 and a right hinge knuckle 17 through which a hinge pin shaft 12 is run, said hinge pin shaft 12 also running through a second left hinge knuckle 19 and second right hinge knuckle 11, the second left hinge knuckle 19 and second right hinge knuckle 11 being integrated with a rigid plate 18 depicted in an “open” orientation exposing a lawnmower discharge 25 as well as the interior wall 26 of the deck member 10. The hinge pin as depicted comprises a shaft 12 and a flattened head 22. Further depicted in FIG. 4 is a partial view of a mechanism whereby the rigid plate 18 may be secured in the “closed” position, the partial view of the mechanism comprising a locking pin 16, a second member 23 integrated with the side of the deck member 10, a third member 24 integrated with the side of the deck member 10, and a pin leash 14 affixed at one end to the locking pin 16 and at a second end to the hinge pin shaft 12. The mechanism whereby the rigid plate 18 may be secured in the “closed” position works by insertion of the locking pin 16 into coaxial perforations in a first member (not viewable in the present FIG. 4) integrated with the face of the rigid plate 18, the second member 23 integrated with the side of the deck member 10, and the third member 24 integrated with the side of the deck member 10. It will be noted that because the rigid plate 18 is depicted in its “open”, the mechanism whereby the rigid plate 18 may be secured in the “closed” position is depicted as it would look when not engaged, the rigid plate 18 being open and exposing the lawnmower discharge 25 and interior wall 26 of the deck member 10.

In more detail, still referring to the invention of FIG. 1, FIG. 2, FIG. 3 and FIG. 4, the preferred embodiment as shown in the varying views include two paramount inventive mechanisms the inventor believes critical in distinguishing the present invention from the prior art—the first being a releasable hinging mechanism whereby the proposed mulch plate is affixed to the rotary lawnmower and the second being a mechanism whereby a mulch plate may be locked in a “closed” or “mulching” configuration obstructing the lawnmower discharge 25. Specifically, it is contemplated that the mulch plate assembly as depicted in the aforementioned figures is quickly and easily removable from the lawnmower by a single unidirectional application of force by a user pulling on the hinge pin flattened head 22 and in a single motion sliding the hinge pin shaft 12 out of the cavities of the first left hinge knuckle 20 and first right hinge knuckle 17 integrated with the deck member and out of the second left hinge knuckle 19 and second right hinge knuckle 11 integrated with the rigid plate 18, thus releasing the rigid plate 18 from the deck member 10. Release of the rigid plate 18 from the deck member 10 results in a fixed configuration of the lawnmower in which the lawnmower discharge 25 and interior wall 26 of the deck member 10 are exposed and, thus, vegetation cut while utilizing the lawnmower is ejected from beneath the deck member 10 rather than maintained therein and converted to mulch as is the case when the rigid plate 18 is secured in a “closed” or “mulching” orientation obstructing the lawnmower discharge 25. When the rigid plate 18 is secured in its “closed” or “mulching” configuration, the second inventive mechanism is utilized, the locking pin 16 being dropped through the coaxial perforations in the first member 15 integrated with the rigid plate 18, the second member 23 integrated with the side of the deck member, and the third member 24 integrated with the side of the deck member. The locking pin 16 has a pin leash 14 securing the locking pin 16 to the hinge pin 12 at all times to prevent loss of the locking pin 16. A further inventive mechanism is believed to be the restraint of the rigid plate 18 in its “open” configuration as depicted in FIG. 4, the restraint accomplished by biased restraint means, preferably a length of elastic material or a biased spring mechanism that is hooked to the rigid plate 18 when in the “open” configuration, thus securing the rigid plate 18 to the deck member 10 or other fixed component of the lawnmower and allowing use of the lawnmower while the rigid plate 18 is in the “open” configuration without need for total removal of the rigid plate 18 via release of the hinge pin shaft 12 by pulling the hinge pin head 22 as described above.

In further detail, still referring to the invention of FIG. 1, FIG. 2, FIG. 3, and FIG. 4, the rigid plate 18 is contemplated to be made of any strong and rigid material including, but not limited to steel, stainless steel, iron, wrought iron, carbon composite, or ceramic. Further, all hinge components including but not limited to the first left hinge knuckle 20, the first right hinge knuckle 17, the second left hinge knuckle 19, the second right hinge knuckle 11, and the hinge pin shaft 12 and head 22 are contemplated to be made of a strong and rigid material comparable to the composition of the rigid plate 18, the aforesaid hinge knuckles being affixed to the rigid plate 18 or deck member 10, as appropriate, by strong attachment means and preferably by weld. Likewise, all components of mechanism securing the rigid plate 18 in the “closed” or “mulching” configuration including but not limited to the locking pin 16, first member 15 integrated with the rigid plate 18, second member 23 integrated with the side of the deck member 10, and third member 24 integrated with the side of the deck member 10 are contemplated to be made of a strong and rigid material comparable to the composition of the rigid plate 18, the aforesaid members being affixed to the rigid plate 18 or deck member 10, as appropriate, by strong attachment means and preferably by weld. The locking pin leash 14 is contemplated to be composed of any durable but flexible material including without limitation wire, small gauge wire rope, or small gauge steel cable.

I claim:

1. In a rotary lawnmower having a deck member featuring a discharge aperture wherein grass clippings and the like are discharged during use of the lawnmower, a mulch plate assembly comprising—
a rigid plate member; and
attachment means whereby the rigid plate member is attached to the deck member in configuration so as to obstruct the discharge aperture, the attachment means able to be engaged or disengaged by a user.

2. The mulch plate assembly of claim 1 wherein the attachment means is a hinge assembly comprising one or more hinge knuckles integrated with the deck member, one or more hinge knuckles integrated with the rigid plate member, and a hinge pin that completes the hinge assembly when inserted through all hinge knuckles, the hinge assembly enabling attachment of the rigid plate member to the deck member in a first position in which the rigid plate member obstructs the discharge aperture and a second position in which the rigid plate does not obstruct the discharge aperture.

3. The mulch plate assembly of claim 2 wherein the hinge pin is removable, causing disengagement of the hinge assembly when the hinge pin is removed by a user and causing engagement of the hinge assembly when the hinge pin is inserted through all hinge knuckles by a user.

4. The mulch plate assembly of claim 2 wherein the rigid plate member is coupled with locking means whereby the rigid plate member may be locked in the first position in which the rigid plate member obstructs the discharge aperture.

5. The mulch plate assembly of claim 4 wherein the locking means is a slide lock assembly that facilitates the locking of the rigid plate member to the deck member.

6. The mulch plate assembly of claim 2 wherein the rigid plate member is coupled with restraint means whereby the rigid plate member may be restrained in the second position in which the rigid plate does not obstruct the discharge aperture.

7. The mulch plate assembly of claim 6 wherein the restraint means is a shock cord or compression spring attached at a first end to the rigid plate member and attached at a second end to the deck member.

8. The mulch plate assembly of claim 6 wherein the rigid plate member is coupled with locking means whereby the rigid plate member may be locked in the first position in which the rigid plate member obstructs the discharge aperture.

9. A mulch plate assembly to be integrated with a power rotary lawnmower, the assembly comprising—
a rigid deck member having a downwardly projecting skirt;
an aperture in the deck member skirt;
a rigid plate member of sufficient surface area to completely obstruct the aperture;
hinging means whereby the rigid plate member is joined to the rigid deck member and may be configured in a first position in which the rigid plate member obstructs the discharge aperture and a second position in which the rigid plate does not obstruct the discharge aperture;
locking means whereby the rigid plate member may be locked in the first position in which the rigid plate member obstructs the discharge aperture; and
restraining means whereby the rigid plate member may be restrained in the second position in which the rigid plate does not obstruct the discharge aperture.

10. The mulch plate assembly of claim 9 wherein the hinging means comprise one or more hinge knuckles integrated with the deck member, one or more hinge knuckles integrated with the rigid plate member, and a removable hinge pin whereby the hinging means is engaged when the hinge pin is inserted through all hinge knuckles, and the hinging means is disengaged when the hinge pin is removed.

11. The mulch plate assembly of claim 9 wherein the locking means is a slide lock assembly whereby the rigid plate member may be locked to the deck member.

12. The mulch plate assembly of claim 9 wherein the restraint means is a shock cord or compression spring attached at a first end to the rigid plate member and attached at a second end to the deck member.

13. The mulch plate assembly of claim 12 wherein the locking means is a slide lock assembly whereby the rigid plate member may be locked to the deck member.

14. A power rotary lawnmower comprising—
a deck member having a downwardly projecting skirt defining a downwardly facing cavity;
a set of three or more wheels;
a combustion engine mounted on the deck member, the combustion engine engaging a vertical shaft projecting downwardly through the deck member into the cavity;
a cutting blade attached at the bottom of the vertical shaft in a horizontal plane within the cavity;
an aperture in the deck member skirt;
a rigid plate member of sufficient surface area to completely obstruct the aperture;
hinging means whereby the rigid plate member is joined to the rigid deck member and may be configured in a first position in which the rigid plate member obstructs the discharge aperture and a second position in which the rigid plate does not obstruct the discharge aperture;
locking means whereby the rigid plate member may be locked in the first position in which the rigid plate member obstructs the discharge aperture; and
restraining means whereby the rigid plate member may be restrained in the second position in which the rigid plate does not obstruct the discharge aperture.

15. The power rotary lawnmower of claim 14 wherein the hinging means comprises one or more hinge knuckles integrated with the deck member, one or more hinge knuckles integrated with the rigid plate member, and a removable hinge pin whereby the hinging means is engaged when the hinge pin is inserted through all hinge knuckles, and the hinging means is disengaged when the hinge pin is removed.

16. The power rotary lawnmower of claim 14 wherein the locking means is a slide lock assembly whereby the rigid plate member may be locked to the deck member.

17. The power rotary lawnmower of claim 14 wherein the restraint means is a shock cord or compression spring attached at a first end to the rigid plate member and attached at a second end to the deck member.

18. The power rotary lawnmower of claim 17 wherein the locking means is a slide lock assembly whereby the rigid plate member may be locked to the deck member.

19. A power rotary lawnmower comprising—
a deck member having a downwardly projecting skirt defining a downwardly facing cavity;
a set of three or more wheels;
a combustion engine mounted on the deck member, the combustion engine engaging a vertical shaft projecting downwardly through the deck member into the cavity;
a cutting blade attached at the bottom of the vertical shaft in a horizontal plane within the cavity;
an aperture in the deck member skirt;
a rigid plate member of sufficient surface area to completely obstruct the aperture;
a hinge assembly comprising one or more hinge knuckles integrated with the deck member, one or more hinge knuckles integrated with the rigid plate member, and a hinge pin that completes the hinge assembly when inserted through all hinge knuckles, the hinge assembly enabling attachment of the rigid plate member to the deck member in a first position in which the rigid plate member obstructs the discharge aperture and a second position in which the rigid plate does not obstruct the discharge aperture;
a slide lock assembly whereby the rigid plate member may be locked in the first position in which the rigid plate member obstructs the discharge aperture; and
a shock cord or compression spring attached at a first end to the rigid plate member and attached at a second end to the deck member whereby the rigid plate member may be restrained in the second position in which the rigid plate does not obstruct the discharge aperture.

20. A mulch plate assembly to be integrated with a power rotary lawnmower, the assembly comprising—
a rigid deck member having a downwardly projecting skirt;
an aperture in the deck member skirt;
a rigid plate member of sufficient surface area to completely obstruct the aperture;
a hinge assembly comprising one or more hinge knuckles integrated with the deck member, one or more hinge knuckles integrated with the rigid plate member, and a hinge pin that completes the hinge assembly when inserted through all hinge knuckles, the hinge assembly enabling attachment of the rigid plate member to the deck member in a first position in which the rigid plate member obstructs the discharge aperture and a second position in which the rigid plate does not obstruct the discharge aperture;
a slide lock assembly whereby the rigid plate member may be locked in the first position in which the rigid plate member obstructs the discharge aperture; and
a shock cord or compression spring attached at a first end to the rigid plate member and attached at a second end to the deck member whereby the rigid plate member may be restrained in the second position in which the rigid plate does not obstruct the discharge aperture.
